(19) United States
(12) Patent Application Publication
(10) Pub. No.: US 2009/0267458 A1
(43) Pub. Date: Oct. 29, 2009

(54) APPARATUS FOR PREVENTING EAVESDROPPING USING PIEZOELECTRIC FILM

(76) Inventors: Kwang Uk Chu, Seoul (KR); In Ho Hwang, Daejeon (KR); Choon Sik Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/347,528

(22) Filed: Dec. 31, 2008

(30) Foreign Application Priority Data
Apr. 23, 2008 (KR) 10-2008-0037661

(51) Int. Cl. G10K 9/122

(52) U.S. Cl. 310/334

(57) ABSTRACT

Provided is an apparatus for preventing eavesdropping using a piezoelectric film. The apparatus includes a vibrator including the piezoelectric film, conductive layers connected to top and bottom surfaces of the piezoelectric film, and electrodes connected to the conductive layers, and a noise signal generator electrically connected to the vibrator to generate and transmit an electrical noise signal to the vibrator. The vibrator generates vibration in a solid body in close contact with itself in response to the electrical noise signal.

### CROSS-REFERENCE TO RELATED APPLICATION

This application claims priority to and the benefit of Korean Patent Application No. 2008-37661, filed on Apr. 23, 2008, the disclosure of which is incorporated herein by reference in its entirety.

### BACKGROUND

1. Field of the Invention

The present invention relates to an apparatus for preventing eavesdropping using a piezoelectric film and, more specifically, to an apparatus for preventing eavesdropping using a piezoelectric film that is attached to a window or wall in order to prevent attempts to sense minute vibration of the window or wall due to sound waves from human voices.

2. Discussion of Related Art

Modern technology has made it possible to eavesdrop on indoor-conversations by measuring minute vibration of a window, door, or wall due to sound waves from human voices.

To prevent eavesdropping, jamming techniques have been developed. For example, a vibrator may be attached to a window, door, or wall to generate artificial noise vibration, so that even if vibration of the window, door, or wall is measured using eavesdropping apparatuses, it is difficult to understand conversations.

FIG. 1 illustrates a first example of a conventional apparatus for preventing eavesdropping.

Referring to FIG. 1, the conventional apparatus for preventing eavesdropping includes two vibrators 101 and 105 and a noise signal generator 103. The vibrators 101 and 105 closely contact an object 100, such as a window, door, or wall, which can vibrate due to sound waves. The noise signal generator 103 is connected to the vibrators 101 and 105.

In general, the vibrators 101 and 105 are attached at corners of the window where they are less visible. When one vibrator is enough for one window 100, each of the vibrators 101 and 105 may be attached at one corner of a corresponding window 100, as shown in FIG. 1. In this case, the output impedance of the noise signal generator 103 may be appropriately designed Such that the two vibrators 101 and 105 are connected in parallel to the single output terminal using a pair of electrical wires. In the apparatus shown in FIG. 1, the noise signal generator 103 generates an appropriate noise signal, and the vibrator (or an additional vibrator) 101 vibrates the window or wall in response to the noise signal, thereby jamming vibration of the window or wall due to sound waves. Specifically, the noise signal generator 103 generates a white noise or colored noise signal which the vibrator 101 converts into noise vibration to drown out vibration due to sound waves. As a result, even if the vibration of the window or wall is measured, an eavesdropping apparatus cannot discern the vibration due to sound waves from the vibration caused by the vibrator 101.

FIG. 2 illustrates a second example of a conventional apparatus for preventing eavesdropping.

The apparatus shown in FIG. 2 is based on the same principle as the apparatus shown in FIG. 1 insofar as vibrators 201, 203, 205, and 207 and a noise signal generator 211 are used. However, unlike the apparatus shown in FIG. 1, the apparatus shown in FIG. 2 is adopted when a target object, such as a window or a door, has a large area and requires more than one vibrator.

Referring to FIG. 2, when a window 200 is twice as wide as the window 100 shown in FIG. 1, two vibrators 201 and 203 may be used. Thus, vibrators 201, 203, 205, and 207 may be attached at diagonally opposite corners of the sliding windows 100. In this case, two of the vibrators 201, 203, 205, and 207 must be connected by electrical wires to a corresponding output terminal of the noise signal generator 211, making electrical connection of the vibrators 201, 203, 205, and 207 much more complicated than in the apparatus of FIG. 1.

In most cases, since a conference room or an office to which the above-described apparatus for preventing eavesdropping is likely to be applied has many very large windows, more vibrators are required.

Therefore, in the conventional apparatuses for preventing eavesdropping, the number of vibrators depends on the size of the window, and the arrangement of the vibrators and electrical wires connected to the vibrators becomes complicated for larger windows.

In addition, when a vibrator is brought into close contact with a sliding window, the following problems may occur.

FIG. 3 is a diagram for explaining problems of a conventional apparatus for preventing eavesdropping.

FIG. 3 shows a case where the conventional apparatus for preventing eavesdropping is attached to a common sliding window 300. In this case, since a vibrator 301, which is an essential part of the conventional apparatus, is quite thick, when the vibrator 301 is attached inside the sliding window 300, the window 300 may not open. Accordingly, while eavesdropping may be prevented, the window 300 cannot be opened or else the vibrator 301 may detach and fall off.

### SUMMARY OF THE INVENTION

The present invention is directed to an apparatus for preventing eavesdropping using a piezoelectric film.

The present invention is also directed to an apparatus for preventing eavesdropping that generates noise vibration using a piezoelectric film to facilitate electrical wiring and application to ordinary windows.

One aspect of the present invention provides an apparatus for preventing eavesdropping using a piezoelectric film. The apparatus includes: a vibrator including the piezoelectric film, conductive layers connected to top and bottom surfaces of the piezoelectric film, and electrodes connected to the conductive layers; and a noise signal generator electrically connected to the vibrator to generate and transmit an electrical noise signal to the vibrator wherein the vibrator generates noise vibration in a solid body in close contact with itself in response to the electrical noise signal transmitted from the noise signal generator.

The solid body may be a material capable of vibrating in response to an external sound signal. Each of the conductive layers may be selected from the group consisting of a conductive metal layer, a conductive polymer layer, and an organic conductive layer. The piezoelectric film may be formed of a material selected from the group consisting of polyvinylidenefluoride (PVDF), hexafluoropropylene (HFP), vinylidenefluroethylene (VDF/TrFE) polymer, and fluorine resin. Each of the electrodes may be formed by adhering a metal tape coated with a conductive adhesive to the conductive layer. Alternatively, each of the electrodes may be formed by printing silver paste or conductive mixture ink on the conductive layer. The apparatus may further include a protective film coated on the entire surface of the vibrator. Alternatively, the protective film may be coated on the entire surface of the vibrator except a portion that is in close contact with the solid body. The noise vibration may have a frequency capable of jamming vibration of the solid body in response to an external sound signal. The vibrator may be cut to a size corresponding to the size of the solid body brought into close contact with the vibrator.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a diagram illustrating a first example of a conventional apparatus for preventing eavesdropping;

FIG. 2 is a diagram illustrating a second example of a conventional apparatus for preventing eavesdropping;

FIG. 3 is a diagram for explaining problems of a conventional apparatus for preventing eavesdropping;

FIG. 4 schematically illustrates a vibrator according to an exemplary embodiment of the present invention; and

FIG. 5 is a diagram illustrating an apparatus for preventing eavesdropping using a piezoelectric film according to an exemplary embodiment of the present invention.

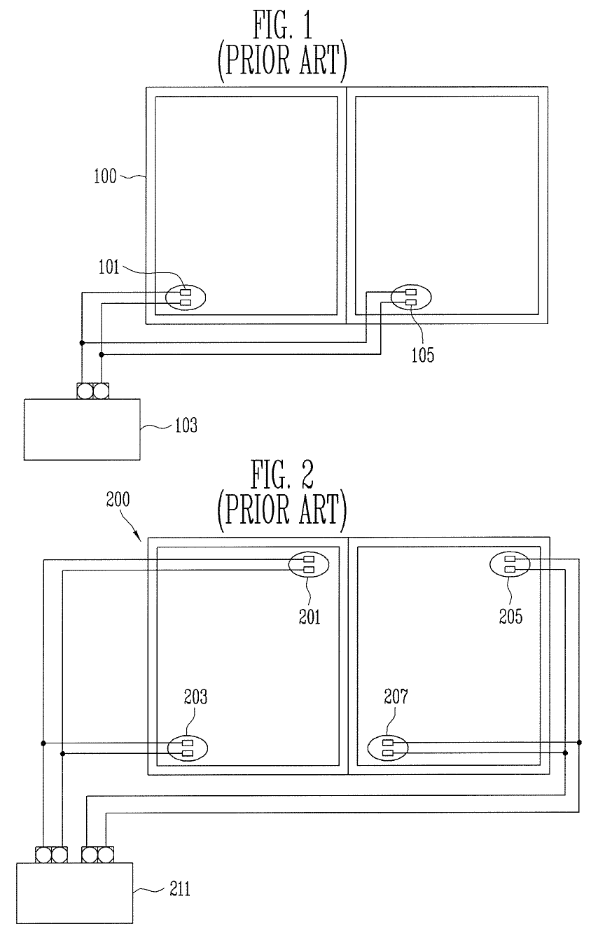

### DETAILED DESCRIPTION OF EXEMPLARY EMBODIMENTS

Hereinafter, an apparatus for preventing eavesdropping using a piezoelectric film according to an exemplary embodiment of the present invention ill be described in detail with reference to the accompanying drawings.

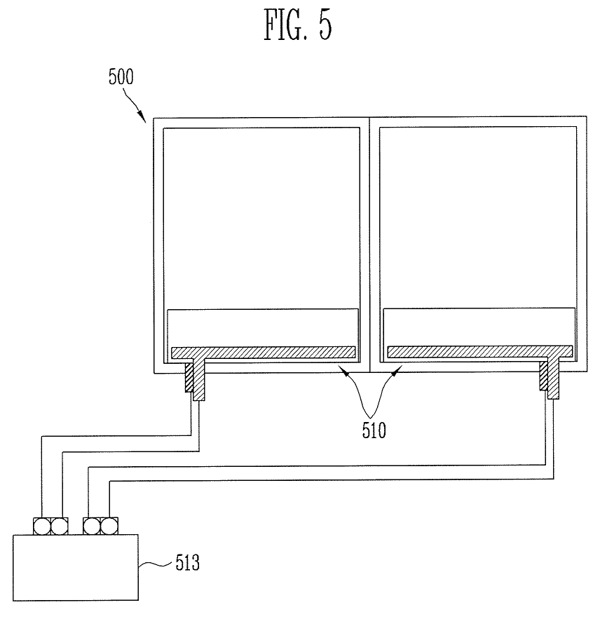

FIG. 4 schematically illustrates a vibrator according to an exemplary embodiment of the present invention.

Referring to FIG. 4A, a vibrator 400 according to an exemplary embodiment of the present invention includes a piezoelectric film 401, conductive layers 403, electrodes 407 and 409, and a protective film 405. The vibrator 400 is brought into close contact with a vibrating medium 420 Such as a window or wall. Reference numerals 430 and 440 are cross-sectional views taken along line 410.

The piezoelectric film 401, which is the most essential part of the vibrator 400, is formed of a piezoelectric material that converts an electrical signal into physical vibration.

The piezoelectric film 401 may be formed of a material selected from the group consisting of polyvinylidenefluoride (PVDF), hexafluoropropylene (HFP), vinylidenefluroethylene (VDF/TrFE) polymer, and fluorine resin.

The conductive layers 403 are used to apply electric signals to the piezoelectric film 401. The conductive layers 403 may be formed of a highly conductive metal such as copper (Cu), silver (Ag), gold (Au), and aluminum (Al), or a nonmetal such as a conductive polymer or an organic conductive material, for example, polyaniline, polythiophene, poly3,4-ethylene dioxythiophene (PEDOT), polypyrrole, or polyphenylenevinylene (PPV).

As can be seen from FIG. 4, the electrodes 407 and 409 may be an upper electrode 407 and a lower electrode 409, which function as contact points for transmitting electric signals causing the piezoelectric film 401 to vibrate. The upper and lower electrodes 407 and 409 may be formed by adhering a metal tape coated with a conductive adhesive to the conductive layer 403 or printing silver paste or conductive mixture ink on the conductive layer 403.

The protective film 405 is used to protect the piezoelectric film 401, the conductive layer 403, and the upper and lower electrodes 407 and 409. The protective film 405 may be formed of a polymer such as polyethylene, polyvinyl chloride, polyethylene terephthalate, or derivatives thereof.

The vibrator 400 may be brought into close contact with the vibrating medium 420, such as a glass panel, door, or wall, and generates noise vibration capable of jamming vibration caused by sound waves.

When the vibrator 400 in reference numeral 430 is combined with the vibrating medium, such as a window, a contact medium 411, such as an adhesive, may be used to ensure close adhesion of the vibrator 400 to the vibrating medium. In this case, however, since vibration is indirectly transmitted to the vibrating medium through the protective film 405 and the contact medium 411, vibration efficiency is not optimal.

In the vibrator in reference numeral 440, unlike the vibrator in reference numeral 430, a protective film 441 is coated on the entire surface of the vibrator 400 except a portion closely contacting the vibrating medium 420. In this case, the vibrator 400 directly transmits vibration to the vibrating medium 420, which is a more efficient way to transmit vibration to the vibrating medium 420. Here, vibration can be directly transmitted to the vibrating medium 420 since the vibrator 400 is closely adhered to the vibrating medium 420 using the contact medium 411, such as an adhesive.

As shown in FIG. 4, the vibrator 400 according to the present invention may have the form of a long roll with stub-type electrodes attached at regular intervals. Then, no matter how big or small the vibrating medium 420 is, the vibrator 400 can simply be cut to a size corresponding to the size of the vibrating medium 420. Accordingly, it is very easy to attach the vibrator 400 compared to conventional apparatuses for preventing eavesdropping.

FIG. 5 is a diagram illustrating an apparatus for preventing eavesdropping using a piezoelectric film according to an exemplary embodiment of the present invention.

Referring to FIG. 5, a vibrator 510 of an apparatus for preventing eavesdropping according to an exemplary embodiment of the present invention may be adhered to a large window 500, and electrodes of the vibrator 510 may be connected to a noise signal generator 513. With this configuration, eavesdropping through vibration of the window 500 can be prevented.

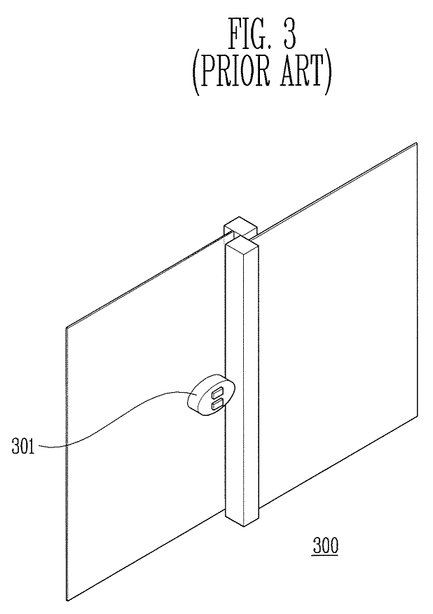

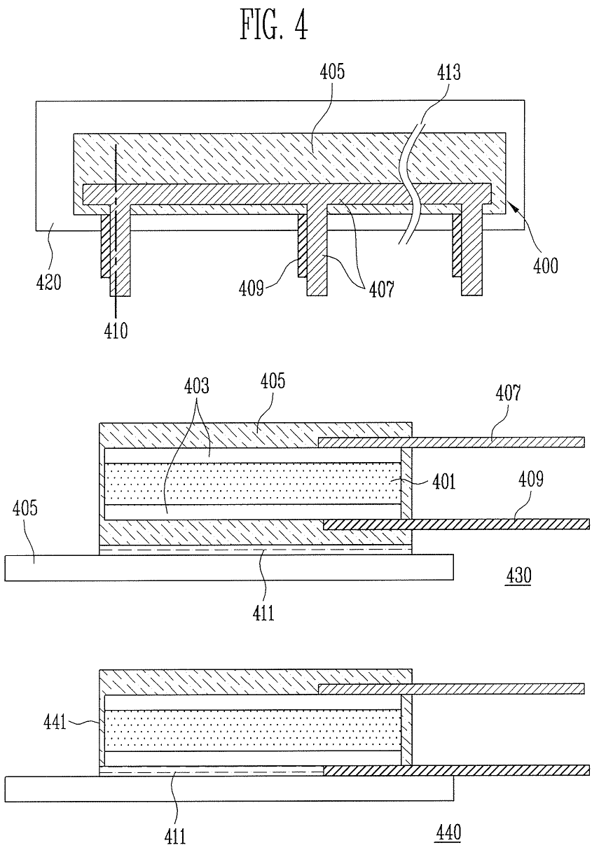

It can be seen that electrical wiring of the apparatus shown in FIG. 5 is very simple compared to the conventional apparatus shown in FIG. 2. Also, even if the window 500 is a sliding window, the thinness of the vibrator 510 according to the present invention makes it easy to open and close the window 500.

In particular, since the vibrator 510 according to the present invention closely contacts the entire bottom surface of the window 500, it is only necessary to cut the vibrator 510 according to the size of the window 500. Therefore, unlike the conventional art, there is no need to attach several vibrators on larger windows.

As described above, an apparatus for preventing eavesdropping according to the present invention can generate noise vibration using a piezoelectric film so that wiring can be simplified and the apparatus can be attached to ordinary windows.

While exemplary embodiments of the invention are illustrated in the drawings and described above in specific terms, neither the drawings nor the above description are not intended to place any limitations whatsoever on the purpose, constitution, or effects of the invention itself. Those of ordinary skill in the art may discover that various changes in form and details can be made to the exemplary embodiments. However, let it be clear that such changes do not constitute changes to the invention itself as long as they do not depart from the scope of the following claims.

What is claimed is:

1. An apparatus for preventing eavesdropping using a piezoelectric film, comprising:
a vibrator including the piezoelectric film, conductive layers connected to top and bottom surfaces of the piezoelectric film, and electrodes connected to the conductive layers; and
a noise signal generator electrically connected to the vibrator to generate and transmit an electrical noise signal to the vibrator, wherein the vibrator generates noise vibration in a solid body in close contact with itself in response to the electrical noise signal transmitted from the noise signal generator.

2. The apparatus according to claim 1, wherein the solid body is made of a material capable of vibrating in response to an external sound signal.

3. The apparatus according to claim 1, wherein each of the conductive layers is one selected from the group consisting of a conductive metal layer, a conductive polymer layer, and an organic conductive layer.

4. The apparatus according to claim 1, wherein the piezoelectric film is formed of a material selected from the group consisting of polyvinylidenefluoride (PVDF), hexafluoropropylene (HFP), vinylidenefluroethylene (VDF/TrFE) polymer, and fluorine resin.

5. The apparatus according to claim 1, wherein each of the electrodes is formed by adhering a metal tape coated with a conductive adhesive to the conductive layer.

6. The apparatus according to claim 1, wherein each of the electrodes is formed by printing silver paste or conductive mixture ink on the conductive layer.

7. The apparatus according to claim 1, further comprising a protective film coated on the entire surface of the vibrator.

8. The apparatus according to claim 7, wherein the protective film is coated on the entire surface of the vibrator except a portion that is in close contact with the solid body.

9. The apparatus according to claim 1, wherein the noise vibration has a frequency capable of jamming vibration of the solid body in response to an external sound signal.

10. The apparatus according to claim 1, wherein the vibrator is cut to a size corresponding to the size of the solid body brought into close contact with the vibrator.
